(19) United States
(12) Patent Application Publication
(10) Pub. No.: US 2014/0157132 A1
(43) Pub. Date: Jun. 5, 2014

(54) SYSTEMS AND METHODS FOR SELECTIVELY DELIVERING MESSAGES TO MULTIUSER TOUCH SENSITIVE DISPLAY DEVICES

(71) Applicant: EMO2 INC., Palo Alto, CA (US)

(72) Inventor: Mir Abid HUSSAIN, Kerala (IN)

(73) Assignee: EMO2 INC., Palo Alto, CA (US)

(21) Appl. No.: 13/691,092

(22) Filed: Nov. 30, 2012

(51) Int. Cl. G06F 3/048

(52) U.S. Cl. CPC G06F 3/048
USPC 715/738

(57) ABSTRACT

In a system including a server that manages multiuser touch sensitive display devices in a closed network using descriptive tags, each device having a touch sensitive display screen, wherein each of the devices is tagged with tags, a method for selectively delivering messages to display devices selected from the tagged display devices, is provided. The method includes: providing a first interface for a user to browse and select the tags; upon the user's selection of one or more tags, presenting to the user a first set of devices that are tagged with the selected tags and displaying information pertinent to the devices in the first set; providing a second interface for the user to modify the first set based on the information such that the user can select a second set of devices from the first set; and delivering messages of the user's selection to the second set of devices.

### CROSS REFERENCE TO RELATED APPLICATIONS

This application is related to the following applications filed concurrently herewith on Nov. 30, 2012:

U.S. patent application Ser. No. ______, entitled “Systems and Methods for Changing Orientation of Display Windows and Contents;”

U.S. patent application Ser. No. ______, entitled “Systems and Methods for Controlling a User's Ability to Browse the Internet;”

U.S. patent application Ser. No. ______, entitled “Systems and Methods for Authenticating a User Based on Multiple Inputs Received from Multiple Devices;”

U.S. patent application Ser. No. ______, entitled “Systems and Methods for Processing Simultaneously Received User Inputs;” and

U.S. patent application Ser. No. ______, entitled “Apparatus and Methods for Mounting a Multiuser Touch Sensitive Display Device.”

### FIELD OF THE INVENTION

The disclosed subject matter relates to the field of managing a network of display devices.

### BACKGROUND

Display devices such as, touch input based display devices, pen input based display devices or gesture/camera input based display devices. A touch screen display device may include a capacitive touch screen or one or more infrared (IR) sensors or the same maybe built using an in-cell display. Such devices are located in various establishments, such as, banks, cafes and malls, among other places.

Conventionally, the content to be displayed in such devices is preconfigured. Hence, if one wishes to change the content to be displayed in such devices, then each device will have to be reconfigured to display the desired content.

Further, if an establishment operates a host of display devices spread across various locations, the establishment lacks the ability to configure the content to be displayed in a subset of their devices, based on desired criteria, from a remote location.

Furthermore, establishments might wish to display content on their devices, wherein the content may not necessarily correspond to the establishment, and thereby monetize their devices. However, conventional technologies do not appear to provide a platform for establishments to easily monetize their devices.

Conventional technologies do not appear to provide a platform for businesses to easily identify and target a network of display devices or users who use these devices.

### SUMMARY

The invention provides a system for managing a network of display devices. The system includes a server, wherein the server is configured to activate one or more devices, assign at least one or more tags to the device(s) and communicate with the device(s) based on one or more tags assigned to the device. Tags are identifiable bits of information that maybe associated with devices in-order to group devices under different characteristics. These tags are then exposed to multiple actors in the system that then use them to target and perform actions.

There is also provided a method for managing a network of display devices. The method includes activating one or more devices, assigning at least one or more tags to the device(s), and communicating with the device(s) based on one or more tags assigned to the device(s) by a server.

For example, a café chain owns several display devices. All of these devices are tagged. The café chain then needs to install a software application that was created by a third-party developer who is willing to pay for such software to be made available on the devices. The process to achieve that can be—an application list is presented to the café admin which includes the software application from the third-party developer in the list. The café admin can then select the software he wants to install followed by the tag he wants to associate the software with and the software is installed in all of those devices tagged by the café admin in the first place.

Additionally, several businesses would want to engage with their potential customers by targeting advertisements through such devices or businesses may wish to make available social interaction among users using these devices or businesses may wish to allow users to subscribe to certain aspects of their business with the help of these tags and then deliver services based on subscriptions or businesses may allow 3^{rd} party developers access to certain tags using which games could be built. For example, an airport lounge for leisure travellers may provide tags around travel and location.

To begin with the devices in the lounge are tagged by their location. This helps the lounge operator to identify how well each individual lounge is doing and retarget content available on the devices. Users may simply like the lounge and choose to subscribe to offers and services from the lounge operator. An understanding of how many users use the devices versus how many subscribe maybe a good measure of how well each lounge is delivering services. The lounge operator may also decide to deliver totally different services based on the lounge location or even collect anonymous feedback based on lounge location tag. The lounge also needs to learn more about its users so it may choose to tag the devices with the tag “travel”. Which could be a good indicator to the outside world about the kind of business the lounge runs. Users may then be offered the option to subscribe to the travel tag. Users who love travelling will subscribe to the travel tag. Once the device is tagged with travel and location tags it becomes easy for advertisers, developers and other 3^{rd} parties to target features for the devices. Local travel companies may post offers to users who subscribed to travel the travel tag. Advertisers may offer cheap airline tickets or hotel bookings Developers may create an application that enables like-minded travellers to communicate and make friends among each-other

In a system including at least one server that manages a network of a plurality of multiuser touch sensitive display devices in a closed network using a plurality of descriptive tags, each display device having a touch sensitive display screen, wherein each of the plurality of networked multiuser touch sensitive display devices is tagged with at least one of the plurality of descriptive tags, a method for selectively delivering messages to a set of display devices that is selected from the plurality of tagged display devices, is provided. The selection is made by a user based on identities and descriptions of the plurality of descriptive tags. The method includes: providing a first interface for connecting to the at least one server for a first user to browse the plurality of tags and select one or more tags from the plurality of descriptive tags; upon the first user's selection of the one or more tags from the plurality of descriptive tags, presenting to the first user through the first interface a first set of display devices that are tagged with the selected one or more tags and displaying characteristic information pertinent to the display devices in the first set of display devices including a total number of the display devices in the first set of display devices; providing a second interface for the first user to modify the first set of display devices that are tagged with the selected one or more tags based on the characteristic information such that the first user can further select a second set of display devices from the first set of display devices; and delivering at least one first message of the first user's selection to the second set of display devices by selectively multicasting the at least one first message to the second set of display devices.

### BRIEF DESCRIPTION OF DRAWINGS

Embodiments are illustrated by way of example and not limitation in the Figures of the accompanying drawings, in which like references indicate similar elements and in which:

FIG. 1 illustrates a block diagram of system 100 configured to authenticate devices in accordance with an embodiment;

FIG. 2 is a flowchart illustrating a method 200 for tagging a device 106, in accordance with an embodiment;

FIG. 3 is a flowchart illustrating, the method 300 for delivering advertisements or content including games, apps, news, stock quotes, commerce or weather among other forms of content to devices 106, in accordance with an embodiment;

FIG. 4 is a flowchart illustrating, the method 400 for deploying themes to devices 106, in accordance with an embodiment; and

FIG. 5 is a block diagram illustrating of system 500 configured to allow advertising or content including games, apps, news, stock quotes, commerce or weather among other forms of content of 502c products and services on 502a and 502b network devices, in accordance with an embodiment.

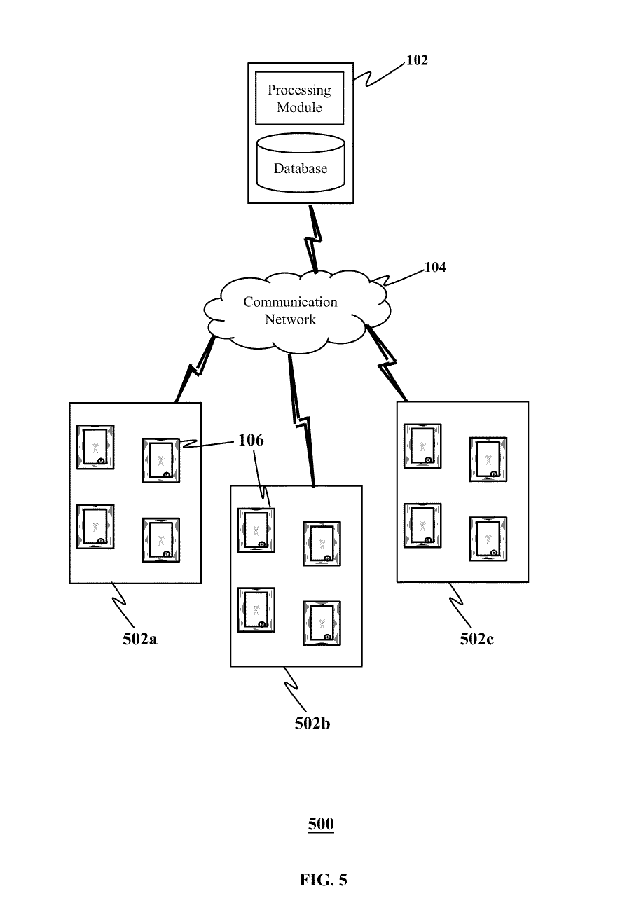

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

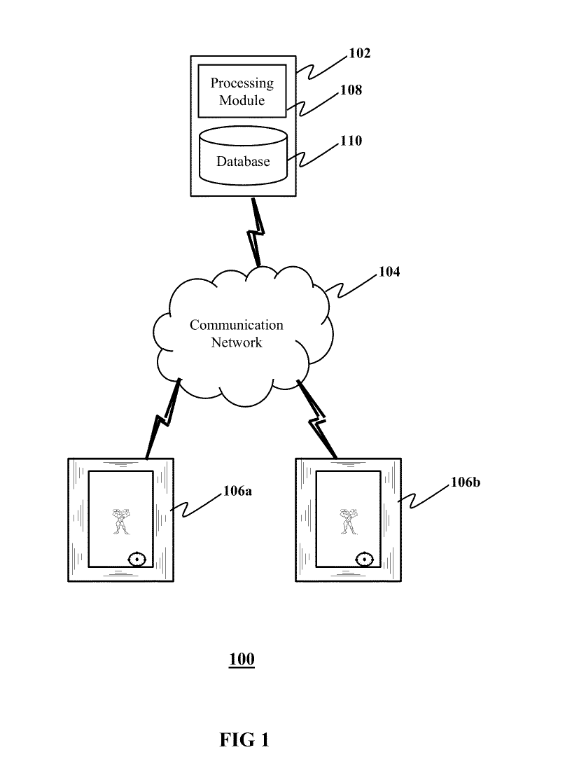

FIG. 1 illustrates a block diagram of system 100 configured to authenticate devices, in accordance with an embodiment. System 100 includes a server 102, communication network 104 and multiple devices 106a and 106b.

System 100 includes a server 102, a communication network 104 and multiple devices 106a and 106b (collectively referred to as “devices 106” or “device 106”, if reference is made to a single device).

In an embodiment server 102 can include a processing module 108 and a database 110, among other modules. The processing module 108 is associated with the database 110 and is configured to process the data received from the devices 106, among other data. The database 110 is configured to store the credentials associated with users and devices 106.

In an embodiment, elements of the server 102 may exist as a single system at one location or each of the elements may separately exist at different locations. One or more of these elements may be coupled with one or more other elements, to perform the intended function.

In an embodiment, communication network 104 can be, for example, wired communication network, wireless communication network and a combination of both wired and wireless communication networks.

In an embodiment, devices 106 can be an electronic device including a display unit, processing unit and an interface to communicate with other devices.

In an embodiment, processing module 108 can be configured to generate credentials. The generated credentials are stored in the database 110. Further, to activate a device 106, the server 102 can receive credentials from the device 106, which can be verified by the processing module 108 by comparing the received credentials with the credentials available in the database 110. On positive verification, the device 106 is activated.

In an embodiment, the processing module 108 can be configured to generate a credential. The generated credential can be used to activate a predefined number of devices 106.

In an embodiment, the credentials can be pre-stored in the device 106. Further, when the device is connected to the server 102, the processing module 108 receives the pre-stored credentials and activates the device 106.

In another embodiment, the credentials can be manually provided by the user of the device 106. When the device 106 is connected to the server 102, the processing module 108 receives the manually provided credentials and activates the device 106.

In an embodiment, a user can include an administrator of the device 106 and users using the device 106, among other users.

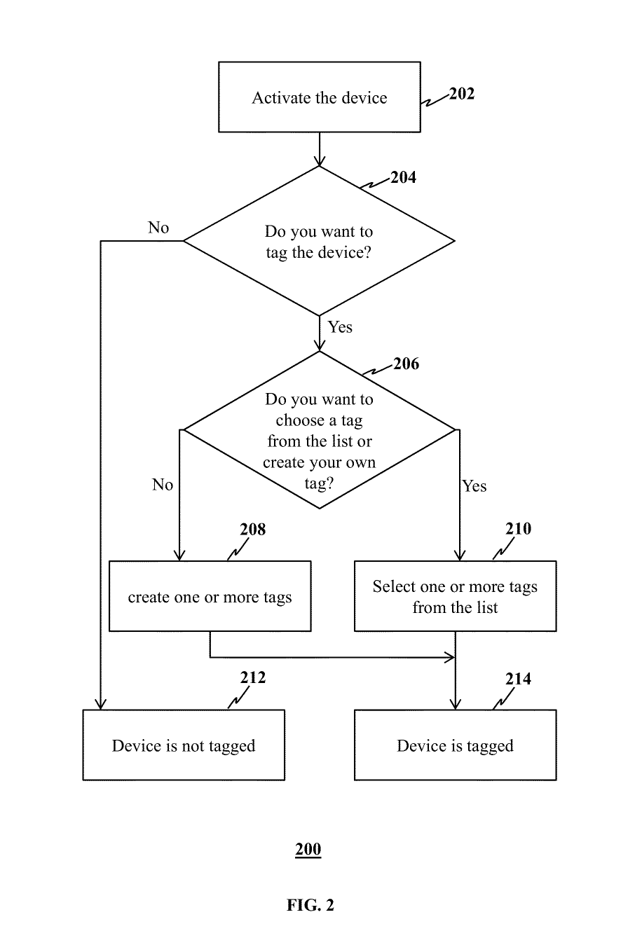

FIG. 2 is a flowchart illustrating a method 200 for tagging a device 106, in accordance with an embodiment. At step 202, the device is activated. At step 204, the user is provided with an option to tag the device. If a user opts not to tag the device, then at step 212 the device is operated without tagging. In the case of untagged devices the user may later choose to tag the untagged device from the same or different interface. While tagging an untagged device later the user may not need to activate the device as the device may already be activated. If the user chooses to tag the device at any stage, then at step 206, the user is provided with an option to either create a user defined tag or choose, one or more tags from the predefined tags available in the server 102. At step 208, an interface to create one or more tags is provided to users, who choose to create a user defined tag. Further, the device 106 is tagged with the user defined tag at step 214. At step 210, an interface to choose one or more tags is provided to users, who choose to tag the device 106 with pre-defined tags. The device 106 is tagged with the selected one or more pre-defined tags at step 214.

In an embodiment, tags assigned to the devices 106 are keywords used to describe the nature of business associated with the device 106. The tags assigned to the device 106 can include, name of the business, type of the business, products, services, keywords and location, among other factors.

In an embodiment, method 200 for tagging a device 106 can include an additional step of, allowing the user to select multiple devices and implement selective tagging from a list of created tags or pre-selected tags from the server 102.

In an embodiment, method 200 for tagging a device 106 can include an additional step of allowing the user to modify the tags assigned to the devices.

In an embodiment, method 200 for tagging a device 106 can be performed by an administrator using an interface made available to him by the server 102. The administrator can recognise the device using a device identifier, which may be assigned to the device when the device is authenticated. Alternatively, the administrator can assign device identifier to each of the device 106 over which he has authority.

In an embodiment, an administrator or user can copy a theme or content assigned to one or more devices to other devices, which are under his authority, using an interface made available to him through the server 102.

In an embodiment, method 200 for tagging a device 106 can include an additional step of, the server 102 suggesting tags to the user based on some pre-defined factor. These pre-defined factors can include location of the device and previous tags used for the device, among other factors.

In an exemplary embodiment, a device 106 placed in a restaurant can be tagged with the name of the restaurant, type of cuisine and type of music played in the restaurant, among other factors. For example, tags used by the restaurant can be pizza hut, burger king, Italian cuisine, Chinese cuisine, vegetarian, non-vegetarian, smoking, non-smoking, pub, burger, biryani, rock, and jazz, among other descriptive tags.

In an embodiment, a customer or user using device 106 can authenticate himself, and subscribe (or indicate interest) to one or more tags. After which Communication, e-commerce, targeted advertising or social networking can be established based on tags and user preferences. Customers or users subscribed to the same tags can communicate and network or buy/sell among each other and brands can target such users with advertisements based on the tags that the user subscribed as well as considering demographics among other factors

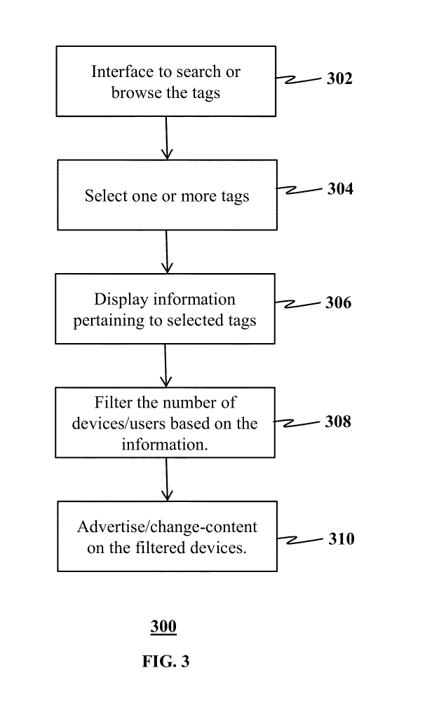

FIG. 3 is a flowchart illustrating, the method 300 for delivering advertisements and content to devices 106, in accordance with an embodiment. At step 302, server 102 provides an interface to browse and search tags associated with devices 106. An advertiser or administrator is allowed to select one or more tags at step 304. At step 306, information pertaining to the selected tags is displayed to the advertiser. Further, at step 308, the advertiser or administrator is provided with an option to filter the devices or users based on the information displayed by the server 102. At step 310, the server 102 delivers the advertisement or content to the filtered devices or users based on preferences setup by the administrator, advertiser and users.

In an embodiment, the method 300 for delivering advertisements to devices 106, can include an additional step of, saving the filtered results on the server 102 under the advertisers account.

In an embodiment, according to method 300, the information displayed to the advertiser or administrator can include information relating to total number of devices listed under the selected tag, location of the devices, nature of business where the device is installed, products and services of the business where the device is installed, among other details.

In an embodiment, according to method 300, the server 102 is configured to allow the advertiser or administrator to filter the devices 106 based on the number of pre-determined factors. The factors for example can include location of the devices, nature of business where the device is installed, products and services of the business where the device is installed, user subscriptions or preferences among other factors. Server 102 is configured to deliver these advertisements or content to the filtered devices/users 106.

In an embodiment, an administrator associated with the device 106 can configure the device such that, the device does not receive advertisement or content from the server 102 based on pre-defined factors. The pre-defined factors used by the administrator can include time, tags, location and competitors, among other pre-determined factors.

In an embodiment, the server 102 can enable the advertiser to configure the advertisements and content to be delivered to the devices 106 based on pre-determined factors. The pre-determined factors allowed by the server 102 can include time, tags, location and competitors, among other pre-determined factors.

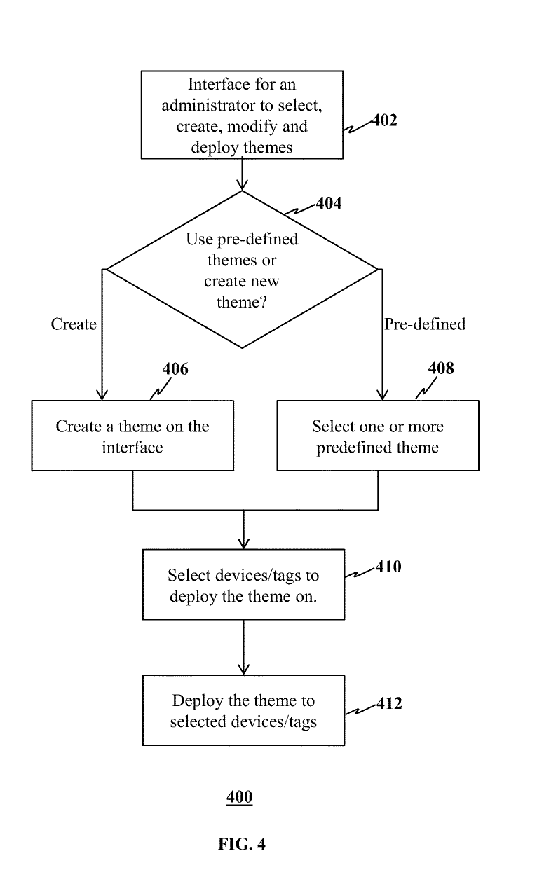

FIG. 4 is a flowchart illustrating, the method 400 for deploying themes to devices 106, in accordance with an embodiment. At step 402, the server provides an interface to an administrator of the device 106. The interface enables the administrator to select, create, modify and deploy themes to one or more devices 106, which are under his control. At step 404, an option is provided on the interface to either choose one or more pre-defined themes or create a new theme. If the administrator opts to create a theme, then at step 406, the interface facilities the creation of the theme. Further, the created theme can be added to the list of themes. Alternatively, if the administrator selects a pre-defined theme, then at step 408, the interface provides an option to use the selected theme. At step 410, the interface allows the administrator to select one or more devices 106, to deploy the theme. Further, at step 412, the themes are deployed to the selected devices based on the selection.

In an embodiment, the method 400 for deploying themes to devices 106 can include an additional step of allowing the administrator to modify the selected pre-defined themes, before deploying them on the devices 106.

In an embodiment, the method 400 for deploying themes to devices 106, can include an additional step of allowing the administrators to select multiple pre-defined or created themes and selectively deploy them on multiple devices 106.

In an embodiment, the users are allowed to login and customise the themes on the device 106. Further the devices can be configured to display the same theme to the user on future logins.

In an embodiment, the administrator can create rules for selectively deploying themes on one or more devices. The rules can be based on factors such as, holidays, events, birthdays, special offers and time of the day, among other factors.

In an embodiment, when a user of the device 106 logs into the device 106 using their social networking credentials, the device retrieves the users' social networking data or user preferences and deploys a theme, based on the data retrieved. For example, data retrieved can be date of birth and anniversaries, among other details. The theme deployed can be based on the data retrieved. The theme shown could also be a user selected theme which the user prefers from a list of themes while such selection is saved as part of user preferences on the server.

It may be noted that, similar to configuring themes, one can configure, for example, content, apps and games, among others on tagged and untagged devices. As an example let's take the case of a Coffee Chain which is deploying touch screen display devices whereby it becomes important for the café chain to remotely assign prices of menu items that they may wish to sell via the touch screen display device. Under such circumstances the café chain may decide to tag the devices by location. They may then price lattes in one location at $10 based on demand while another location may sell the same latte at $9 due to lower demand. The same café chain may also decide to configure games on the devices based on regional sensitivities. Users in some location may love ice hockey while users in another location may not be ice hockey fans. The café chain keeping this trend in mind may alter the game selection on the device to feature ice hockey game more prominently on devices in the location where ice hockey is preferred. The same may also apply to content during festivities such as Christmas. Users may during Christmas season prefer to listen to Christmas music. Given so, the café chain may configure Christmas carols on the devices for users to listen to during the season. Such music may then be made available only to users who subscribed to the tag “Christmas”.

In an embodiment, when a user of the device 106 logs into the device 106, using their social networking credentials, the server 102 can locate the user. Further, server 102 can allow the user to automatically share information with other users on his network. In an embodiment, the location of the user is shared with the information shared by the user, wherein the location information is sourced from the device's location information or user provided location information.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. In a system including at least one server that manages a network of a plurality of multiuser touch sensitive display devices in a closed network using a plurality of descriptive tags, each display device having a touch sensitive display screen, wherein each of the plurality of networked multiuser touch sensitive display devices is tagged with at least one of the plurality of descriptive tags, a method for selectively delivering messages to a set of display devices that is selected from the plurality of tagged display devices by a user based on identities and descriptions of the plurality of descriptive tags, the method comprising:
providing a first interface for connecting to the at least one server for a first user to browse the plurality of tags and select one or more tags from the plurality of descriptive tags;
upon the first user's selection of the one or more tags from the plurality of descriptive tags, presenting to the first user through the first interface a first set of display devices that are tagged with the selected one or more tags and displaying characteristic information pertinent to the display devices in the first set of display devices including a total number of the display devices in the first set of display devices;
providing a second interface for the first user to modify the first set of display devices that are tagged with the selected one or more tags based on the characteristic information such that the first user can further select a second set of display devices from the first set of display devices; and
delivering at least one first message of the first user's selection to the second set of display devices by selectively multicasting the at least one first message to the second set of display devices.

2. The method of claim 1, further comprising:
collecting at the at least one server from each of the plurality of networked display devices descriptive information related to the each networked display device comprising (i) device-based descriptive information including a type of the each display device, a type and version number of an operating system running on the each display device, identifications of application programs running on the each display device and (ii) location-based descriptive information including an address where the each display device is located, a type of place where the each display device is located, and a primary purposes served by the each display device; and
generating the plurality of descriptive tags using the descriptive information.

3. The method of claim 1, wherein the at least one first message includes advertisement messages and the first user includes an advertiser.

4. The method of claim 1, wherein the plurality of descriptive tags includes a first set of tags for different names of restaurants, a second set of tags for different cuisines prepared by the restaurants, and a third set of tags for different amenities offered by the restaurants.

5. The method of claim 1, further comprising identifying at least one second user who has logged on one or more of the plurality of multiuser touch sensitive display devices and subscribed to at least one of the descriptive tags that are used to tag the one or more multiuser touch sensitive display devices.

6. The method of claim 5, wherein the at least one server is configured to send at least one second message to the at least one second user.

7. The method of claim 6, wherein the at least one second message includes advertisement messages related to one of the at least one descriptive tags.

8. The method of claim 5, wherein the at least one server is configured to receive from one of the at least one second user at least one third message and multicast the at least one third message to at least one of other second users and one or more of the display devices related to one of the at least one descriptive tags selected by the second user.

9. The method of claim 8, wherein one of the at least one descriptive tags includes a tag describing a historic significance of locations of the one or more multiuser touch sensitive display devices and the at least one third message includes an “I was there” message.
